(19) United States
(12) Patent Application Publication
(10) Pub. No.: US 2026/0254152 A1
(43) Pub. Date: Aug. 27, 2026

(54) COMPACT SURFACE-MOUNTED HOUSING

(71) Applicant: HARTING ELECTRIC STIFTUNG & CO. KG, Espelkamp (DE)

(72) Inventor: Chuan Sheng DING, Zhuhai (CN)

(21) Appl. No.: 18/844,335

(22) PCT Filed: Feb. 20, 2023
(86) PCT No.: PCT/DE2023/100138

§ 371 Date: Sep. 5, 2024

(30) Foreign Application Priority Data
Mar. 9, 2022 (CN) 202210221889.0

(51) Int. Cl. H01R 13/518; H01R 13/506; H01R 13/52; H01R 13/652; H01R 13/73; H01R 24/76

(52) U.S. Cl. CPC H01R 13/518; H01R 13/506; H01R 13/5202; H01R 13/5221; H01R 13/652; H01R 13/73; H01R 24/76

(57) ABSTRACT

A compact surface-mounted housing is provided including an upper shell and a lower shell which are fastened to one another, wherein the lower shell includes a hollow body which includes, at the top, a connecting flange of the lower shell for connecting to the upper shell, two mounting flanges, arranged on its bottom, of the lower shell which each extend to the outside starting from opposite sides of the body, and two cable leadthroughs which are each arranged on the opposite sides. The surface-mounted housing is of compact design, saves installation space, fulfils the IP68/IP69 protection classes, complies with the EMC requirements, and is corrosion-resistant and oxidation-resistant.

### BACKGROUND

### Technical Field

The present disclosure relates to a surface-mounted housing which is used for connectors, such as industrial connectors.

### Description of the Related Art

Surface-mounted housings for existing connectors, such as industrial connectors, are standard products that are robust and require a large amount of installation space, thereby generally giving rise to high costs.

### BRIEF SUMMARY

Embodiments of the present disclosure provide a surface-mounted housing for industrial connectors which is of compact construction, saves installation space, and results in low costs.

The present disclosure provides a compact surface-mounted housing which includes an upper shell and a lower shell, which are fastened to one another, wherein the lower shell includes a hollow body that includes, at the top, a connecting flange of the lower shell for connection to the upper shell, two mounting flanges of the lower shell, which are arranged on its bottom and each extend outward starting from opposite sides of the body, and two cable leadthroughs, which are each arranged on the opposite sides.

In one advantageous embodiment, it is envisaged that the upper shell includes a continuous hollow body which, at the top, includes an upper mounting flange of the upper shell, a polygonal projection, which projects from the mounting flange of the upper shell, and a connecting flange of the upper shell, which flange is arranged on its bottom, for connection to the connecting flange of the lower shell.

In one advantageous embodiment, it is envisaged that the connecting flange of the lower shell is provided on each of its opposite sides with a threaded opening, wherein two mutually opposite central threaded openings are provided within the body of the upper shell, wherein the central threaded openings in the upper shell are aligned with the threaded openings in the connecting flange of the lower shell during the assembly of the upper shell and the lower shell, wherein the upper shell and the lower shell are secured to one another by a securing element. The securing element may be a screw, a bolt or the like. Screws are passed through the central threaded openings in the upper shell and the threaded openings in the connecting flange of the lower shell, said openings being aligned with one another, in order to secure the upper shell and the lower shell together. Securing is achieved by an internal locking mechanism, wherein no additional space is required and thus installation space is saved.

In one advantageous embodiment, it is envisaged that a sealing groove for the reception of a first sealing ring is provided on the connecting flange of the upper shell, and/or a sealing groove for the reception of a second sealing ring is arranged on a side wall of the polygonal projection. When the upper shell and the lower shell are secured together, the first sealing ring ensures sealing between the connecting flange of the upper shell and the connecting flange of the lower shell. When the upper shell and a housing of a mating connector are plugged together, the second sealing ring ensures sealing between the upper shell and the housing of the mating connector. A housing which provides a degree of protection up to IP68/IP69 is thereby obtained.

In one advantageous embodiment, it is envisaged that the mounting flanges of the lower shell each include two mounting portions and a protective ground connecting portion arranged between them, which projects relative to the mounting portions, wherein the protective ground connecting portion has a hole for screwing in a protective ground screw in order to achieve protective grounding. In some embodiments, each of the two mounting flanges of the lower shell may have a protective ground connecting portion, thereby implementing the connection between two protective grounds (PG). In some embodiments a hole may be in the mounting portion for screwing in a screw in order to fasten the surface-mounted housing on a device, such as a panel of a switch cabinet or a wall of a building/vehicle compartment.

In one advantageous embodiment, it is envisaged that the lower shell may consist of metal, such as aluminum or an aluminum alloy, wherein, apart from the protective ground connecting portion, the connecting flange of the lower shell and the cable leadthroughs, the outer surface of the lower shell is sprayed with powder. The upper shell may likewise consist of a metal, such as of aluminum or an aluminum alloy. The surface-mounted housing made of metal advantageously forms an EMC (electromagnetic compatibility) connection housing. The outer surface of the lower shell may be sprayed with a black powder coating containing synthetic components (e.g., resin, aldehyde, etc.) in order to protect the lower shell from oxidation and corrosion. Since, however, the protective ground connecting portion, the connecting flange of the lower shell and the cable leadthrough each have to be connected to the protective ground screw, the connecting flange of the upper shell and the cable terminal, these parts are not sprayed with powder. Since the protective ground connecting portion projects relative to the mounting portions, it may not be sprayed with powder during the powder spraying process. The outer surface of the upper shell may also be sprayed with powder.

In one advantageous embodiment, it is envisaged that at least one of the cable leadthroughs may be closed. If the cable has to be connected only from one side, the cable leadthrough on the other side may be closed from the inside of the lower shell.

In one advantageous embodiment, it is envisaged that the cable leadthroughs may be designed in such a way that M20 to M40 cable terminals can be installed. Cables are connected to the lower shell by the cable terminals via the cable leadthroughs. For adaptation to different diameters of the M20 to M40 cable terminals, the cable leadthroughs can also be embodied in different sizes.

In one advantageous embodiment, it is envisaged that the surface-mounted housing may be designed as a bush housing. In one embodiment, the existing modular inserts may be accommodated in the bush housing, while plug contacts may be accommodated in the modular inserts. The housing of the mating connector may be designed as a plug housing.

The provision of the internal locking mechanism ensures that the surface-mounted housing described herein is of compact construction, saves installation space and is convenient for in-situ installation by the user. The two-part arrangement of the upper shell and the lower shell enables the surface-mounted housing to be configured in a flexible manner. The configuration of two sealing elements ensures that the surface-mounted housing achieves the IP68/IP69 degree of protection. By virtue of the configuration of the protective ground connecting portion, the surface-mounted housing forms a PG connection. In addition, the materials of the upper shell and of the lower shell and the process for spraying the surface with powder ensure that the surface-mounted housing meets the EMC (electromagnetic compatibility) requirements and is corrosion-and oxidation-resistant.

### BRIEF DESCRIPTION OF THE SEVERAL VIEWS OF THE DRAWINGS

Embodiments of the present disclosure are illustrated in the drawings and explained in greater detail below.

FIG. 1 shows a perspective view of a surface-mounted housing according to one embodiment of the present disclosure.

FIG. 2 shows an exploded view of the surface-mounted housing in FIG. 1.

FIG. 3 shows a perspective view of a lower shell of the surface-mounted housing in FIG. 1.

FIG. 4 shows a plan view of an upper shell of the surface-mounted housing in FIG. 1.

FIG. 5 shows a bottom view of the upper shell of the surface-mounted housing in FIG. 1.

FIG. 6 shows a sectional view of the surface-mounted housing in FIG. 1.

### DETAILED DESCRIPTION

The technical solutions of the present disclosure are described in more detail below by exemplary embodiments and in conjunction with the appended drawings. In the description, identical or similar reference signs denote identical or similar components. The following description of the embodiments of the present disclosure with reference to the appended drawings is intended to explain the general concept of the present disclosure and should not be interpreted as a limitation of the present disclosure.

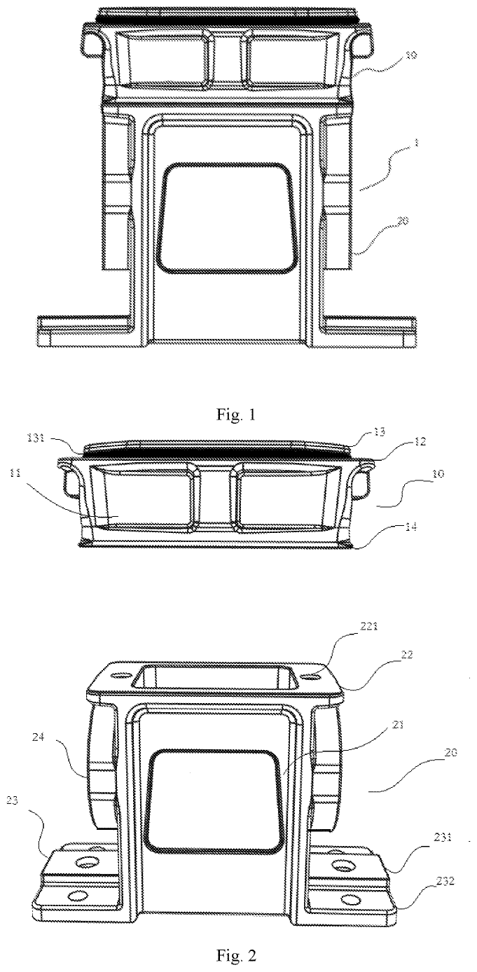

FIGS. 1 and 2 show a perspective view and an exploded view, respectively, of a surface-mounted housing according to one embodiment of the present disclosure. The surface-mounted housing is to be mounted on a device such as a panel of a switch cabinet, a connection socket or a wall of a building/vehicle compartment. In this context, the surface-mounted housing is designed as a bush housing, in which existing modular inserts can be accommodated in order to provide power and/or signal connections. The surface-mounted housing 1 is a two-part housing, which comprises an upper shell 10 and a lower shell 20. During assembly, the two shells are fastened to one another, thereby providing a larger installation space in order to accommodate relatively large modular inserts or a relatively high number of modular inserts so as to transmit higher currents.

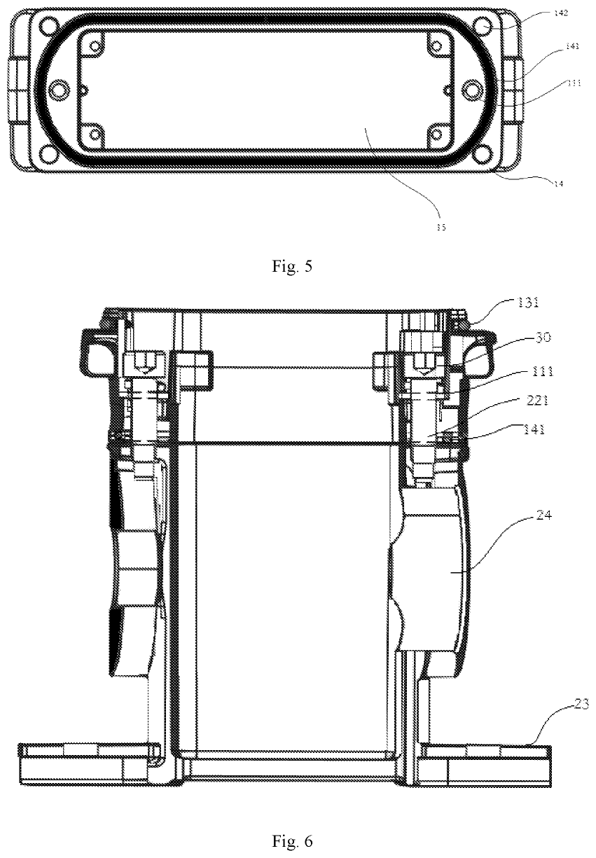

As shown in FIG. 2, the upper shell 10 forms a compact housing, which is rectangular overall. However, a person skilled in the art should understand that the shape of the upper shell is not limited to a substantially rectangular shape, and may be any other shape known in the sector under consideration (e.g., a circle, a square and the like). The upper shell 10 comprises a continuous hollow body 11, that is to say that the upper shell 10 forms a housing, the upper end and lower end of which are open. The body 11 comprises a mounting flange of the upper shell 12, said flange being arranged at the top of the body 11. As shown in FIG. 4, the mounting flange of the upper shell 12 is substantially rectangular, wherein four corners of the rectangle are each provided with a threaded opening 121, wherein the bush housing and a housing of a mating connector (not shown), which is designed as a plug housing, can be assembled together by screws, which are passed through these threaded openings. The body 11 furthermore comprises a connecting flange of the upper shell 14, said flange being arranged at the bottom of the body 11. As shown in FIG. 5, the connecting flange of the upper shell 14 is substantially rectangular, wherein a sealing groove which assumes the shape of a racetrack is provided in the connecting flange of the upper shell 14, wherein a first sealing ring 141 is arranged in the sealing groove. When the upper shell 10 and the lower shell 20 are assembled, the first sealing ring 141 ensures sealing between the upper shell and the lower shell, as clearly shown in FIG. 6. Moreover, the four corners of the connecting flange of the upper shell 14 are preferably each provided with a threaded opening 142, thus enabling the upper shell to be mounted directly on a panel of a device or on a wall of a building/vehicle compartment by screws. The body 11 also comprises a projection 13, which projects from the mounting flange of the upper shell 12. The projection 13 is polygonal and surrounds a through opening 15 in the body 11, as shown in FIG. 4. A sealing groove, in which a second sealing ring 131 is arranged, is provided on an outer side wall of the projection. When the upper shell 10 and a housing of a mating connector (not shown) are assembled, the second sealing ring 131 ensures sealing between the upper shell and the housing of the mating connector. Arranged within the body 11, more specifically on two opposite sides of the through opening 15, there is a respective central threaded opening 111. A hole 112 for mounting a modular insert (not shown) is preferably arranged at each of four corners of the through opening 15. The upper shell consists of a metal, e.g., aluminum or an aluminum alloy, such as from a diecast aluminum, in order to provide an EMC (electromagnetic compatibility) connection housing.

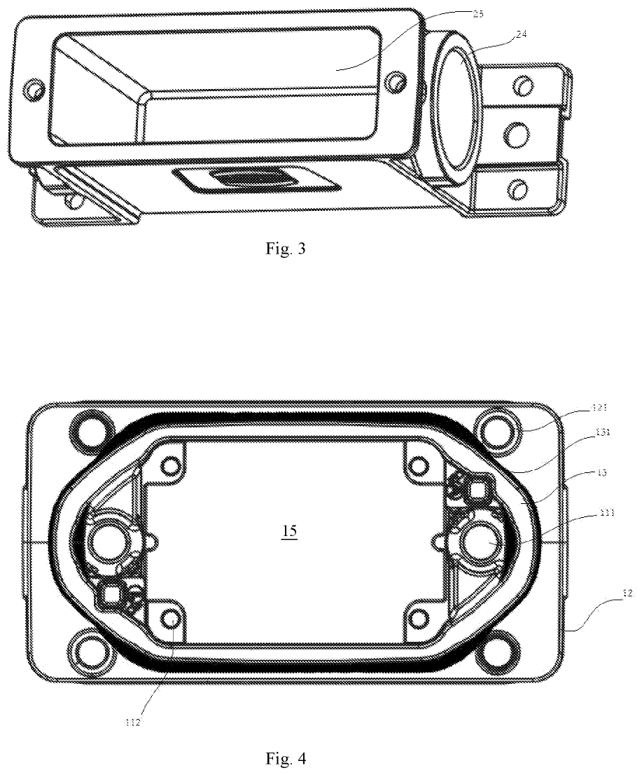

As can be seen in FIGS. 2 and 3, the lower shell 20 is rectangular overall. However, a person skilled in the art should understand that the shape of the lower shell is not limited to a substantially rectangular shape, and may assume any other shape known in the sector under consideration (e.g., a circle, a square and the like). The lower shell 20 comprises a hollow body 21, which forms a bowl having an open upper part and a closed bottom. At the top, the body 21 comprises a connecting flange of the lower shell 22 for connection to the upper shell 10, such as the connecting flange of the upper shell 14. The connecting flange of the lower shell 22 is substantially rectangular and surrounds an opening 25, wherein a respective threaded opening 221 is provided on each of the two opposite sides of the rectangle. When the upper shell 10 and the lower shell 20 are assembled, the threaded openings 221 are each aligned with two central threaded openings 111 in the upper shell, as shown in FIG. 6, after which a securing element, (e.g., a screw, a bolt, etc.) is passed successively through the threaded openings 111 and 221 in order to fasten the upper shell 10 and the lower shell 20 to one another. The first sealing ring 141 ensures sealing between the connecting flange of the lower shell 22 and the connecting flange of the upper shell 14. The body 21 also comprises two mounting flanges of the lower shell 23, which are arranged on its bottom, and each respective mounting flange extends outward starting from opposite sides of the body. The mounting flanges of the lower shell 23 each comprise two mounting portions 232 and a protective ground connecting portion 231 arranged between them, wherein the protective ground connecting portion 231 projects relative to the mounting portions 232. Both the protective ground connecting portions 231 and the mounting portions 232 are each provided with a hole, wherein the hole in the protective ground connecting portion 231 is used for screwing in a protective ground screw (not shown) in order to achieve protective grounding, wherein the hole in the mounting portion 232 is used for screwing in a screw in order to fasten the lower shell 20 on a panel of a device or on a wall of a building/vehicle compartment. The body 21 also comprises two cable leadthroughs 24 arranged on its opposite sides, i.e., lateral cable leadthroughs. The cable leadthroughs 24 are designed in such a way that they can receive M20 to M40 cable terminals (not shown). As shown in FIG. 3, one cable leadthrough can be closed from the inside of the lower shell if it is not required. The lower shell 20 consists of a metal, e.g., aluminum or an aluminum alloy, such as from a diecast aluminum, in order to implement EMC. When used in tough external environments, however, the aluminum housing corrodes and oxidizes easily. In order to avoid this problem, the outer surface of the housing is sprayed with powder, e.g., a black powder coating containing synthetic components (e.g., resin, aldehyde, etc.). Since the protective ground connecting portion 231 of the mounting flange of the lower shell 23 projects relative to the mounting portions 232, the protective ground connecting portion 231 is not sprayed with powder. The cable leadthrough 24 and the connecting flange of the lower shell 22 are not sprayed with powder on account of their being connected to a cable terminal and the upper shell, respectively.

For upper shells of different sizes, lower shells of different sizes that match the upper shells can be designed, thereby providing surface-mounted housings of different sizes.

For a person skilled in the art, it is obvious that the present disclosure is not limited to the details of the illustrative exemplary embodiments described above and that the present disclosure can be implemented in other specific forms without departing from the spirit or the significant features of the present disclosure.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A compact surface-mounted housing, comprising:
an upper shell; and
a lower shell, wherein the lower shell comprises a lower cavity and a lower connecting flange for connection to the upper shell, two mounting flanges arranged on a bottom of the lower shell, wherein each mounting flange extends outward starting from opposite sides of a body of the lower shell, and two cable leadthroughs which are each arranged on the opposite sides of the body.

2. The compact surface-mounted housing as claimed in claim 1, wherein the upper shell comprises an upper cavity which has, at the top of the upper shell, an upper mounting flange, a polygonal projection, which projects from the upper mounting flange, and an upper connecting flange, arranged on a bottom of the upper shell, for connection to the lower connecting flange.

3. The compact surface-mounted housing as claimed in claim 2, wherein the lower connecting flange has a threaded opening in each of the lower connecting flanges opposite sides, wherein two mutually opposite central threaded openings are provided within the upper cavity of the upper shell, wherein the central threaded openings in the upper shell are aligned with the threaded openings in the lower connecting flange during the assembly of the upper shell and the lower shell, wherein the upper shell and the lower shell are fixed to one another by a securing element.

4. The compact surface-mounted housing as claimed in claim 2, wherein the upper connecting flange is provided with a sealing groove for the reception of a first sealing ring, and/or a sealing groove for the reception of a second sealing ring is arranged on a side wall of the polygonal projection.

5. The compact surface-mounted housing as claimed in claim 1, wherein the two mounting flanges each comprise two mounting portions and a protective ground connection arranged between the two mounting flanges, which projects relative to the mounting portions, wherein the protective ground connection has an opening for screwing in a protective ground screw in order to achieve protective grounding.

6. The compact surface-mounted housing as claimed in claim 5, wherein the lower shell consists of metal, and wherein, apart from the protective ground connection, the lower connecting flange and the cable leadthroughs, a lateral surface of the lower shell is powder-coated.

7. The compact surface-mounted housing as claimed in claim 1, wherein one of the cable leadthroughs can be closed.

8. The compact surface-mounted housing as claimed in claim 1, wherein the cable leadthroughs are designed in such a way that M20 to M40 cable terminals can be installed.

9. The compact surface-mounted housing as claimed in claim 1, wherein the housing is designed as a bush housing.
